(19) United States
(12) Patent Application Publication
(10) Pub. No.: US 2014/0316907 A1
(43) Pub. Date: Oct. 23, 2014

(54) MULTILAYERED USER INTERFACE FOR INTERNET BROWSER

(71) Applicant: Asaf NAIM, Kfar Yona (IL)

(72) Inventor: Asaf NAIM, Kfar Yona (IL)

(21) Appl. No.: 14/242,891

(22) Filed: Apr. 2, 2014

Related U.S. Application Data
(60) Provisional application No. 61/812,734, filed on Apr. 17, 2013.

(51) Int. Cl. G06F 3/0484; G06Q 30/02

(52) U.S. Cl. CPC G06F 3/04842; G06Q 30/0277
USPC 705/14.73; 715/777

(57) ABSTRACT

Methods and systems directed to a web browser on a computing device comprising a user graphic interface having at least two layers: at least one layer presenting web browser content; and at least one layer, having at least two visual modes: a semi-hidden mode in which an at least one toolbar is visible; and a visible mode wherein said at least one toolbar and a content tab are visible, wherein the content tab presents content from an at least one pre-defined source and the content tab does not completely hide the at least one layer presenting web browser content.

### BACKGROUND

1. Technical Field

Embodiments of the present invention relate generally to systems and methods for internet (web) browser.

2. Description of Related Art

Conventional web browsers utilize multiple tabs, however, most web browsers allowing easy viewing of only one tab at a time. In addition, all tabs look the same while minimized or hidden, hence not allowing for quick recognition of a specific tab. These user interface drawbacks cause working with conventional web browsers to be far from efficient.

Hence, an improved systems and methods as described in this application are still a long felt need.

### BRIEF SUMMARY

According to an aspect of the present invention, a web browser and/or a web browser extension is provided to allow multilayered user interface.

An aspect of the present invention provides a non-transitory computer-readable medium storing processor executable instructions that include a web browser on a computing device, the browser comprising: a user graphic interface having at least two layers: at least one layer presenting web browser content; and at least one layer, having at least two visual modes: a semi-hidden mode in which an at least one toolbar is visible; and a visible mode wherein said at least one toolbar and a content tab are visible, wherein the content tab presents content from an at least one pre-defined source and the content tab does not completely hide the at least one layer presenting web browser content; wherein the visual modes are toggled in response to user selection.

It is further within provision of the invention to further comprise a manual/automatic authentication process to said at least one pre-defined source.

It is further within provision of the invention to further comprise a point to multipoint communication.

It is further within provision of the invention to further comprise a recipients list extracted from said at least one pre-defined source.

It is further within provision of the invention to further comprise sharing of current web content between user and at least one recipient from said recipients list.

It is further within provision of the invention to further allow the sharing is done via said at least one pre-defined source's social/messaging abilities.

It is further within provision of the invention to further comprise at least one hyperlink in said at least one toolbar wherein activating said hyperlink allow for extraction of content from the respective pre-defined source.

It is further within provision of the invention to further comprise at least one hyperlink in said at least one toolbar wherein activating said hyperlink toggle said visual modes.

It is further within provision of the invention to further allow said toolbar present advertising.

It is further within provision of the invention to further comprise a point to multipoint communication, wherein said multipoint recipients are the advertisers of said advertising.

It is further within provision of the invention wherein the said second at least one layer is partly transparent.

It is further within provision of the invention to further comprise advertising chosen by third party as relevant to the content presented in the first layer.

Another aspect of the present invention provides a method for a non-transitory computer-readable medium storing computer executable instructions that when executed by a computer cause the computer to perform a method, the method comprising: displaying a user graphic interface having a first layer with at least one web browser content and a toolbar; receiving a command to toggle a second layer displaying content from an at least one pre-defined source; displaying said second layer wherein the second layer does not completely hide the first layer presenting web browser content.

It is further within provision of the invention to further comprise step of manual/automatic authentication to said at least one pre-defined source.

It is further within provision of the invention to further comprise steps of: creating a recipients list by extracting information from said at least one pre-defined source; communicating with at least one receipt from said recipients list.

It is further within provision of the invention to further comprise step of communicating with at least one receipt via said at least one pre-defined source's social/messaging abilities.

It is further within provision of the invention wherein said communication content comprise mainly of sharing of current web content.

It is further within provision of the invention to further comprise step of presenting advertising in said toolbar.

It is further within provision of the invention to further comprise steps of: creating a recipients list by extracting information from said advertising's source; communicating with at least one receipt from said recipients list.

It is further within provision of the invention wherein said second layer is at least partly transparent.

It is further within provision of the invention to further comprise steps of: sending first layer content information to remote server; presenting relevant advertising in said toolbar.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates an example browser structure in accordance with one embodiment of the invention; and

FIG. 2 illustrates an example browser structure in accordance with one embodiment of the invention; and

FIG. 3 illustrates an example browser structure in accordance with one embodiment of the invention; and

FIG. 4 is a flowchart illustrating an example method of the current invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing systems and methods for to a web browser or a web browser add on or extension.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The term ‘web browser’ may refer hereinafter to any software that allows viewing and/or surfing files, folders, intranet and internet. Said web browser may be standalone software and/or any web browser extension, any web browser add-on, etc.

The term ‘toggle’ may refer hereinafter to switching on or off or between options of an action, a feature, a process, a software etc. For example, the term “activating a hyperlink” is toggling.

The term ‘hyperlink’ may refer hereinafter to any reference to data that the reader can directly follow, as well as any system allowed buttons, scripts, processes etc.

The invention presents a solution for allowing multilayered working environment within a web browser, hence, allowing a first working layer wherein the user may browse through web sites, files and files folders, applications installed on the local computer, applications accessible via network connection/internet, etc. and a second working layer allowing the user to browse through favorite or predefined web sites, files and files folders etc. while the second layer does not completely cover the first layer, the user will be able to partly see the first layer.

In some embodiments of the present invention, the web browser will be provided with said invention implemented beforehand and in other embodiments the invention will be deployed as an extension or an add-on.

An embodiment of the invention may comprise a user graphic interface having at least two layers.

A first set of layers will allow free browsing, the user will use said first set of layers that may include only one first layer window/tab in the same way users use conventional web browsers today. Hence, typing any URL in the URL line or using hyperlinks to reach any website or local folder/file, without any limitations.

A second set of layers comprising at least two elements.

The first element is a toolbar (also known as sidebar, browsing bar etc). Said toolbar will have at least one hyperlink linking to a pre-defined source. Activating said hyperlink (toggling) will bring into view or switch the view to a window/tab within the web browser in which the user will be able to browse the content from the pre-defined source.

In some embodiments of the invention, said second layer will have a semi-hidden mode and a visible mode. While in semi-hidden mode, the user will only see a toolbar or an hyperlink/icon/button representing the toolbar and while in a visible mode the user will see the content window/tab as well as the toolbar.

In some embodiments of the inventions, said second layer will not completely cover the first layer. In other embodiments of the invention, the second layer will cover only between 65-75 percent of first layer.

In some embodiments of the invention, said toolbar hyperlinks will be graphic icons or other visual representation.

In some embodiments of the invention a multiple toolbars will be available to the user. In other embodiments, said toolbar would be divided into several segments, each in a different position. Said toolbar may be located on the screen according to the user's choice.

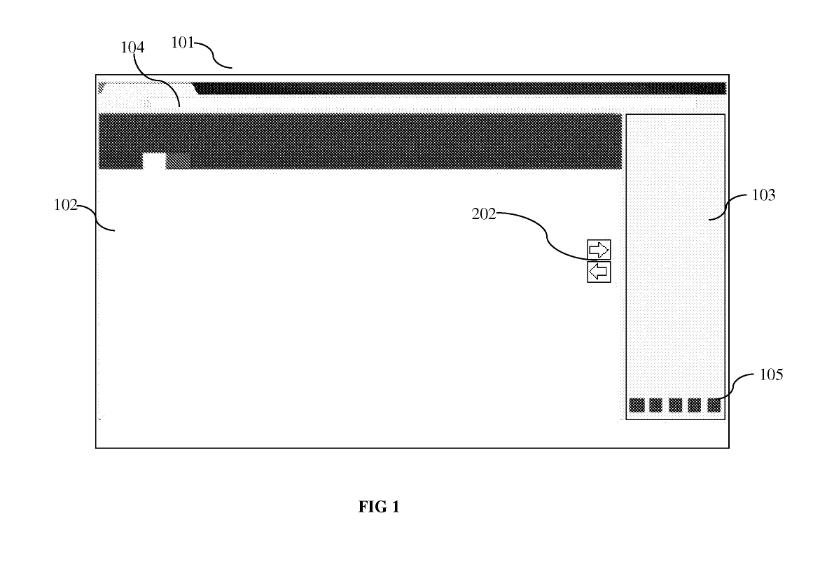

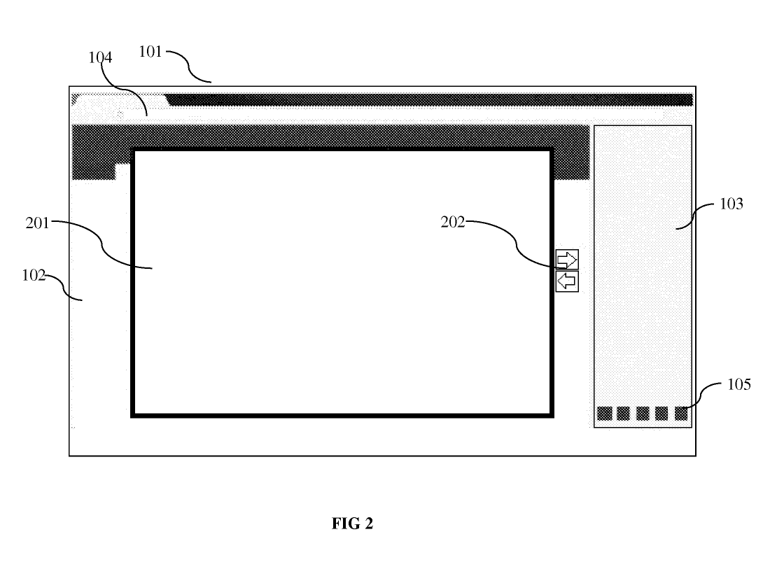

For example, FIG. 1 illustrate an embodiments of the present invention, the user may activate the web browser 101 and then see the first layer 102 (similar to any conventional web browser) and the toolbar 103. While in this example, the user may browse the internet or local folders using the URL line 104 and see the requested content in the first layer window or tab 102. In addition, the user may use the second layer toolbar 103 that contain hyperlinks 105 (in this example in the form of icons) that will link to the pre-defined sources. However, once activating the hyperlink (toggling) the content will not appear in the first layer window or tab, it will appear in a newly opened window or tab belonging to the second layer as illustrated in FIG. 2.

FIG. 2 illustrate an embodiments of the present invention, once the user activated a hyperlink (toggled) in the toolbar, while the second layer was not visible, a newly window or tab 201 will be opened and the content from the specific pre-defined source will be presented there.

In some embodiments of the present invention the second layer window or tab will have some degree of transparency allowing not only seeing some of the first layer content but most of it or at least big portions of it.

Toggling the second layer, in some embodiments of the invention, can be done in several ways:
Activation of a specific hyperlink, for example by pressing the icon in the toolbar, hovering over it or touching a hyperlink in a touch screen will open the second layer window or tab, pressing the icon again will close or hide the window or tab;
Activation of a specific hyperlink, while the second layer window is open or visible with a specific content, will present the content of the new pre-defined source or will open another second layer window or tab.
Using designated hyperlinks or icons 202, the user may bring the second layer to view or to hide it.

In some embodiments of the present invention the second layer window to tab will be closed when not visible, hence, for example, ending the current browsing session, while in other embodiments of the present invention closing said window or tab will only hide it from the user while maintain connection, browsing session etc.

In some embodiments of the present invention a single first/second layer windows or tabs may exist, while in other embodiments several first/second layer windows or tabs may exist.

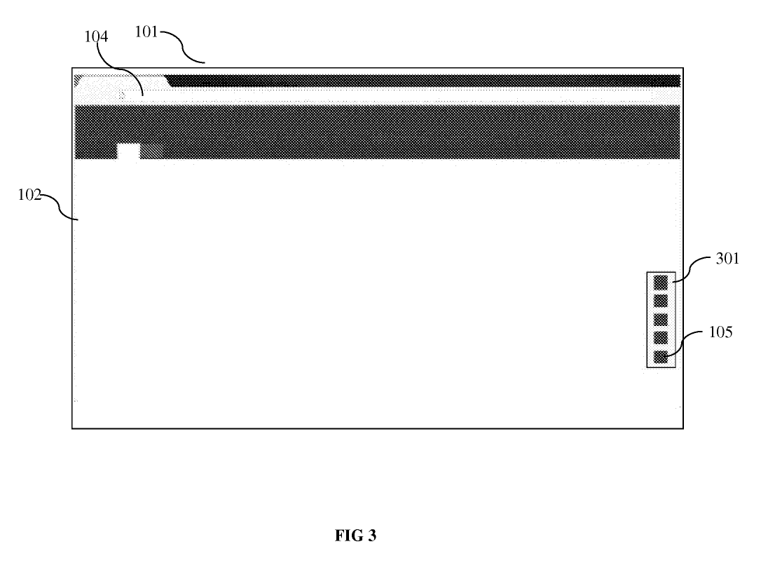

FIG. 3 illustrate an embodiments of the present invention, in this example the toolbar is presented only a small floating toolbar 301.

Said pre-defined sources will usually be the user's favorite or most visited website, file folders, operating system application, software etc. the user will be able to edit, choose and generally define what hyperlinks and in what form will appear in the toolbar.

In some embodiments of the present invention the hyperlinks in the toolbar will activate software and application that were not designed to be run in a web browser (for example windows operating software like MS Word® and Skype®).

Said pre-defined sources may require some forms of user authentication, for example, user may define several social networking website (such as Facebook® etc.) and online email providers (such as Gmail®, Yahoo® etc.), such websites usually require authentication in the form of username and password. Other sources may require stronger authentication, for example, bank website may further require information or even a digital certificate or smart card.

In some embodiments of the present invention the web browser will have the ability to provide the user a single place to define authentication details for each of the pre-defined sources, hence allowing an automatic authentication for those sources. For example, the web browser may automatically perform authentication on start up. In other embodiments, the authentication will happen only when the user request content from a specific source. In different embodiments, the client will be asked to manually type authentication information or otherwise perform authentication on start up or when he request content.

In some embodiments of the present invention the web browser will have an independent messaging ability. This ability will allow users of the browser to communicate with one another in several forms such as typed massaged, video conference, voice calls etc as well as file and information sharing.

In other embodiments of the invention the browser will be able to extract contact information from said pre-defined sources. For example, the browser will be able to create recipients list extracted from Facebook®, Gmail® and other sources having contact information. In other embodiments of the invention the browser will allow communication via pre-defined source's social or messaging abilities.

In some embodiments of the present invention the communication between the user and others will be mainly sharing of current web content, for example the user may browse using the first layer to a website he think that might be useful to a friend. Using the second layer communication option he will share the web content or the URL that is currently present in the first layer. The user will be able to see the first layer, as the second layer does not cover the entire surface of the first layer, hence will have the reassurance that he is not sharing content he does not wish to share.

Said second layer may also include visual real estate to present advertising. Said advertising may show ads provided by a third party (for example, Google Ads®). Said ads may be presented at all times or only when the second layer is visible.

In some embodiments of the present invention, a third party ad management system (again, as Google Ads®) may be aware to the content or URL presented in the first layer and chose to present relevant ads.

The invention allow for an advertiser to associate his advertisement with certain website(s) without having any contact with said website operators. This will allow, for example, displaying ads even in websites that does not allow ads at all or does not allow certain ads. Ads are displayed on the web browser real estate and not on the websites real estate and displaying them does not require any source code embedding or changing in the websites themselves, no connection with the websites operators is required allowing for a complete stand alone advertising platform.

In other embodiments of the invention, the browser will create recipients list that solely contain or include the advertisers, hence allowing direct communication between the user and the advertiser. Said communication may be direct or via third party services.

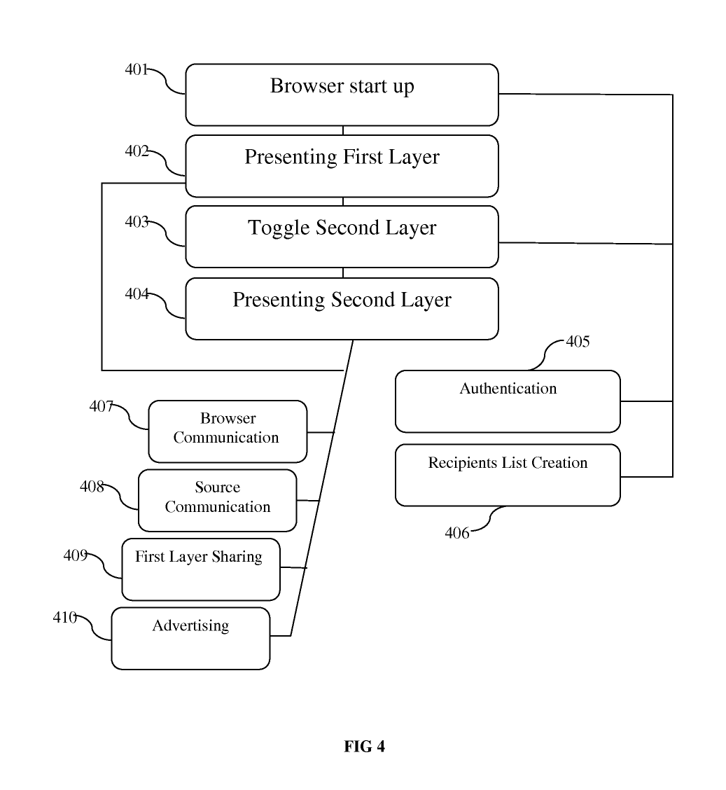

FIG. 4 is a flowchart illustrating an example method of the current invention:
The browser will be started 401 by the user, auto run, script etc.;
During start up, the browser may commence authentication 405 process for all or some of the pre-defined sources;
During or as part of the starting of the browser, the browser may commence in creating recipients list 406;
Once the browser is loaded, the first layer will be presented to the user with toolbar;
Once the user toggled the second layer, the browser may commence in creating recipients list 406 and may commence in creating recipients list 406;
The user will be presented with the second layer;
As long as the toolbar is fully or partly visible, the user may activate any of the browser's capabilities such as:
   Communication with other users;
   Communication with others via third party services or website;
   Share first layer with others;
   Watch advertising.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A non-transitory computer-readable medium storing processor executable instructions that include a web browser on a computing device, the browser comprising:
a user graphic interface having at least two layers:
at least one layer presenting web browser content; and
at least one layer, having at least two visual modes:
a semi-hidden mode in which an at least one toolbar is visible; and
a visible mode wherein said at least one toolbar and a content tab are visible, wherein the content tab presents content from an at least one pre-defined source and the content tab does not completely hide the at least one layer presenting web browser content,
wherein the visual modes are toggled in response to user selection.

2. The browser of claim 1 further comprising a manual/automatic authentication process to said at least one pre-defined source.

3. The browser of claim 1 further comprising a point to multipoint communication.

4. The browser of claim 3 further comprising a recipients list extracted from said at least one pre-defined source.

5. The browser of claim 4 further comprising sharing of current web content between user and at least one recipient from said recipients list.

6. The browser of claim 5 wherein the sharing is done via said at least one pre-defined source's social/messaging abilities.

7. The browser of claim 1 further comprising at least one hyperlink in said at least one toolbar wherein activating said hyperlink allow for extraction of content from the respective pre-defined source.

8. The browser of claim 1 further comprising at least one hyperlink in said at least one toolbar wherein activating said hyperlink toggle said visual modes.

9. The browser of claim 1 wherein said toolbar present advertising.

10. The browser of claim 9 wherein further comprising a point to multipoint communication, wherein said multipoint recipients are the advertisers of said advertising.

11. The browser of claim 1 wherein the said second at least one layer is partly transparent.

12. The browser of claim 9 further comprising advertising chosen by third party as relevant to the content presented in the first layer.

13. A non-transitory computer-readable medium storing computer executable instructions that when executed by a computer cause the computer to perform a method, the method comprising:
displaying a user graphic interface having a first layer with at least one web browser content and a toolbar;
receiving a command to toggle a second layer displaying content from an at least one pre-defined source;
displaying said second layer wherein the second layer does not completely hide the first layer presenting web browser content;

14. The medium performing the method of claim 13 further comprising step of
manual/automatic authentication to said at least one pre-defined source.

15. The medium performing the method of claim 13 further comprising steps of:
creating a recipients list by extracting information from said at least one pre-defined source;
communicating with at least one receipt from said recipients list.

16. The medium performing the method of claim 13 further comprising step of
communicating with at least one receipt via said at least one pre-defined source's social/messaging abilities.

17. The medium performing the method of claim 15 wherein said communication content comprise mainly of sharing of current web content.

18. The medium performing the method of claim 13 further comprising step of
presenting advertising in said toolbar.

19. The medium performing the method of claim 13 further comprising steps of:
creating a recipients list by extracting information from said advertising's source;
communicating with at least one receipt from said recipients list.

20. The medium performing the method of claim 13 wherein said second layer is at least partly transparent.

21. The medium performing the method of claim 18 further comprising steps of:
sending first layer content information to remote server;
presenting relevant advertising in said toolbar.
